(19) United States
(12) Patent Application Publication
(10) Pub. No.: US 2012/0135265 A1
(43) Pub. Date: May 31, 2012

(54) LASER PROCESS FOR PRODUCING METALLIC OBJECTS, AND OBJECT OBTAINED THEREFROM

(75) Inventor: Emanuele Magalini, Caldonazzo (IT)

(73) Assignee: Eurocoating S.P.A

(21) Appl. No.: 12/529,586

(22) PCT Filed: Jul. 7, 2009
(86) PCT No.: PCT/IB09/52950

§ 371 Date: Sep. 2, 2009

(51) Int. Cl. B32B 5/18; B32B 15/01; C08J 7/18

(52) U.S. Cl. 428/613; 427/556; 428/660

(57) ABSTRACT

Procedure for the manufacture of metal articles with a laser includes the following phases. Prepare at least a metal substrate, deposit on said substrate at least a layer of commercially pure zirconium or its alloys in the form of powder. Said layer is cut with at least a laser beam having a ratio between power and translation speed between 0.12-0.20 W·s/mm.

### TECHNICAL FIELD

The present invention relates to a laser process for producing metallic objects, and object obtained therefrom.

In particular, the present invention relates to a procedure for the manufacture of metal articles using commercially pure metal zirconium or its alloys, supplied in the form of powder and worked with a laser beam.

### BACKGROUND ART

In numerous production sectors, machines are today known that make three-dimensional articles by means of the sintering of powders of various materials. These articles can, for example, act as prototypes to be used in different research and development phases applied to a specific product, in all planning and testing phases of a new product.

Alternatively, such articles can directly make up the products to be placed on the market, or again be semi-finished products of these latter products.

The materials in the form of powder which are used to supply such machines can be composed, e.g., of plastic materials, or again of metals or metal alloys or ceramics; obviously, the construction characteristics of the machines vary according to the type of material used.

Some types of machines exist that work in particular with metal powders and realize the sintering of the powders, or particles, by means of a laser beam, which follows a specific course predefined by means of three-dimensional CAD instruments on successive layers of that which afterwards will be the final article. In other words, such machines design the article, layer after layer, on the basis of CAD defined project references characteristic to each product “portion”, represented by each deposited layer of powder material.

For some specific technological applications, e.g., in the endosseous prosthesis production sector—the above-described machines are used in particular to make metal products with specific mechanical characteristics, e.g., wear resistance, corrosion resistance, resistance to high temperatures, etc. At the current state of the art, the known technology of sintering three-dimensional articles—or sintering layers of coating on same—with a laser beam does not allow working with powders of zirconium or its alloys.

In practice, it has in fact been found that, using the known machinery currently available on the market to make objects in powder of zirconium or its alloys, unacceptable results are obtained because pieces cannot be obtained with the desired characteristics, in particular with the necessary porosity and cohesion between the particles.

Furthermore, such lack of cohesion also characterizes the coupling between the different layers of material gradually deposited by the machinery. It can occur therefore that the different layers move and shift one with respect to the other during the piece manufacturing phases. This fact, obviously very disturbing, can also produce the blockage of the metal powder distribution part of the machinery, with consequent damage to the production and even possibly to the machinery itself.

### SUMMARY OF THE INVENTION

One object of the present invention is to upgrade the state of the art.

Another object of the present invention is to develop a laser procedure that allows obtaining metal articles with desired mechanical features and surface finishes.

A further object of the present invention is to present a procedure that allows making metal articles with the desired mechanical features and surface finishes, using innovative materials required for specific applications, in particular commercially pure zirconium and its alloys.

Yet another object of the present invention is to present a procedure for the manufacture of metal articles with a laser in a simple, effective and inexpensive way.

In conformity with an aspect of the invention, a procedure is provided for the manufacture of metal articles with a laser.

In conformity with another aspect of the invention, a metal article is provided.

The claims refer to preferred and advantageous embodiments of the invention.

### BRIEF DESCRIPTION OF DRAWINGS

Other characteristics and advantages of the invention will be made more clearly evident from the description of embodiments of the procedure for the manufacture of metal articles with a laser, and of the article obtained with such procedure, shown by way of approximation on the attached drawing, in which:

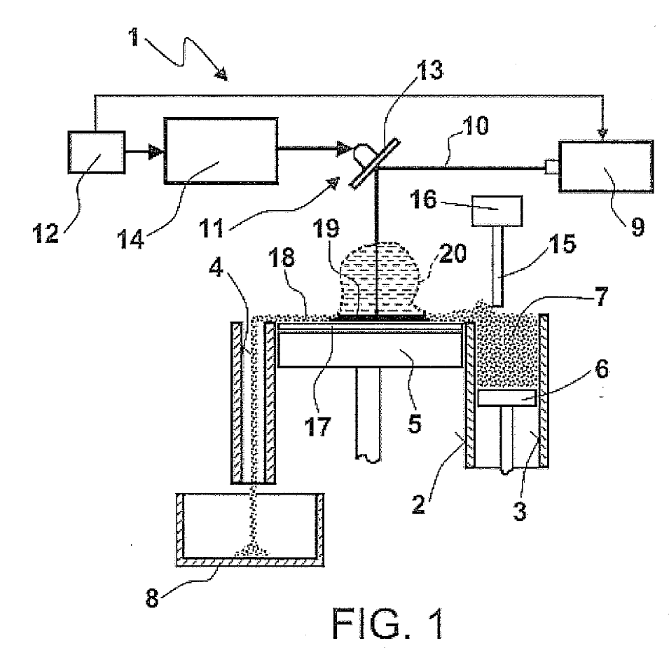

The FIG. 1 is a diagram of the machine used to implement the procedure according to the invention.

### DETAILED DESCRIPTION OF PREFERRED EMBODIMENTS

With particular reference to the FIG. 1, generally indicated by the number 1 is a machine for implementing the procedure of manufacture of metal articles with a laser according to the invention.

It is first of all noted that the machine 1 for the application of the procedure is generally described in its fundamental aspects for the sole purpose of better understanding the phases, and its construction characteristics in no way represent a limitation to the ambit of protection of the invention, with particular reference to the operating phases included in the procedure.

The machine 1 comprises a first chamber 2, open at the top, alongside which are provided a second chamber 3, also open at the top, and a channel 4, arranged substantially vertically. Inside the first chamber 2 a support 5 slides vertically on which is made the metal article, associated with known means of vertical translation not shown in the FIG. 1 for the sake of simplicity.

Inside the second chamber 3 slides vertically a piston 6, coupled with respective known vertical translation parts not shown for the sake of simplicity. This second chamber 6 makes up the supply tank of the powdered metal 7 used to manufacture the metal article.

According to the invention, such metal is composed of commercially pure zirconium or its alloys, made available in the form of substantially spherical particles of size between 20 microns and 45 microns, obtained, e.g., by means of a gas atomization process. The advantages of using this material will appear more evident from the rest of the description.

Below the channel 4, a collection tank 8 is positioned for the excess powder 7, open at the top.

On the top, the machine 1 comprises at least a laser source 9, suitable for projecting a substantially horizontal beam 10, and operating means for operating the laser beam, generally indicated by 11. The source 9 and the operating means 11 are interlocked with a programmable machine processing and control unit 12, of known type.

The operating means 11 of the laser beam 10 can comprise, e.g., a mirror 13, facing the source 9 itself, and a device 14 for adjusting the angle of the mirror 13.

The laser source 9 and the operating means 14 operate according a number of fundamental parameters, which will be analyzed later on.

The machine also comprises a distribution part 15 for distributing the powdered metal 7, associated with horizontal translation means 16.

The procedure for the manufacture of a metal article according to the present invention comprises a first phase in which the support 5 is positioned on a substrate 17 of material, on which the metal to be sintered can adhere without the need for any further weld material. Therefore, e.g., this can be in the form of a solid plate made of a material with characteristics similar to those of the metal to be sintered such as, e.g., commercially pure zirconium, zirconium alloy, titanium, titanium alloy, niobium, niobium alloys.

The second chamber 3 has been previously filled with metal powder 7 up to such a level that this is able to overflow slightly with respect to the upper edge of the first chamber 2. In a subsequent phase of the procedure, the distribution part 15 is made to translate horizontally substantially flush with the substrate 17, and drags with it a certain quantity of metal powder 7. In this way, the distribution part 15 deposits, on the substrate 17, a substantially uniform layer 18 of powder 7, with a thickness of about 20-1000 microns, which can be parallel or not to the above substrate 17.

It is noted that the distribution part 15 can also be mobile according to directions other than horizontal.

The procedure then comprises a phase of cutting of the above layer 18 by means of the laser source 9, thanks to the mirror 13 which reflects the beam 10 itself and projects it on the layer 18. This cutting phase is performed on the basis of the modeling of the article made using three-dimensional CAD, which envisages the segmentation of the article itself in an orderly sequence of two-dimensional drawings, each corresponding to a horizontal layer of the article to be made.

The cut made by the laser source 9 on the surface of the layer 18 of powder 7 determines, in the areas invested by the beam 10, the melting of the particles, which therefore consolidate together creating a compact laminar portion 19 of the article 20 to be created. The phase of cutting by means of the laser source 9 is carried out with operating parameters which, according to the present invention, have been optimized to obtain the desired result with the use of the commercially pure zirconium or its alloys.

In particular, it has been found that, with the use of the commercially pure zirconium or its alloys, perfect results are obtained with a laser source 9 operated with a speed of the beam 10 of 1175 mm/s.

In particular, using a machine like that described here, the speed of the beam 10 can be set and changed by adjusting the angular speed of variation of the inclination of the mirror 13. Furthermore, it has been found that, with the use of the commercially pure zirconium, perfect results are obtained with a laser source 9 operated with a power of the laser beam 10 that, must be 195 W. Considering the continuous innovations of laser technology and the future possibility of having at disposal laser sources of greater power and mirror movement systems sufficiently precise and faster than those currently used, a parameter is fixed dependent on beam power and speed that represents to some extent the energy yielded to the material and which allows escaping the single values listed above. The parameter in consideration is defined ε and is equal to the ratio between power (in Watts) and speed (in mm/s). The interval indicated for this parameter with regards to the use with commercially pure zirconium powder or its alloys is between 0.12 and 0.20 (W·s/mm).

Naturally, the power of the beam 10 can be regulated by means of control devices of the source 9.

Subsequently, the procedure comprises a phase of lowering of the support 5 by a height substantially corresponding to the thickness of the deposited layer 18. This way, in a subsequent phase, by means of the distribution part 15, a subsequent layer of powder 7 is deposited on the one below already cut by the beam 10, thanks to the space created by lowering the support 5. A further cutting phase then follows of the new deposited layer, according to a two-dimensional model corresponding to the portion immediately above deriving from the three-dimensional modeling of the article.

This further phase determines the melting of the particles of powder 7 which consolidate and fasten onto the already-made compact laminar portion below.

The phases of cutting of the beam 10 and deposit of layers of powder 7 follow one another alternately until the metal article has been completely manufactured; any excess powder is unloaded inside the channel 4, until it drops into the collection tank 8. Finally, the procedure comprises a phase of separation of the metal article from the non-solidified powder 7, and, if necessary, a phase of detachment of the article itself from the substrate 17. In the deposit applications of a surface coating on a substrate, which represents an integral part of the article to be made, this phase of detachment is obviously not envisaged. Further finishing phases of the articles can then be provided or, if necessary, phases involving the carrying out of heat treatments to obtain the required mechanical characteristics. The metal article made using the procedure according to 5 the invention has, at least in the part made directly with the cutting of the laser beam 10—if necessary therefore excluding the substrate if made from a different material—the mechanical, physical and chemical characteristics of the commercially pure zirconium or of one of its alloys. The articles obtained using the present procedure are distinguished, e.g., by high surface roughness and high porosity, with extension and depth of pores greater than that of the articles already available on the market: this makes these articles particularly suitable for particular biomedical uses such as, e.g., endosseous prostheses.

By way of non-limitative example, a number of data are provided relating to the roughness and porosity obtainable using the present procedure.

Thanks to the present procedure, the metal article 20 can comprise a surface layer with a thickness generally between 100 μm and 2000 μm of high roughness and with porosity between 40% and 80%.

Furthermore, the pores have a depth generally between 100 μm and 2000 μm, and more in particular between 500 μm and 1000 μm, such depth being much greater than those obtainable using traditional technologies.

The optimization of the operating parameters of the source 9 of the laser beam 10, with particular, but not only, reference to the translation speed and to the power of the beam 10, allows bringing the spherical particles of zirconium to melting point so that they can consolidate the one with the other, thereby creating solid structures with the desired mechanical and surface finish characteristics.

The procedure to which the present invention relates can, in any case, be applied, without any limitation whatsoever, to the production of metal articles of any size and intended for any use whatsoever.

The present invention has been described according to preferred embodiments, but equivalent variations can be conceived without exiting from the protection ambit offered by the claims.

1. Procedure for the manufacture of metal articles with a laser, comprising the following phases:
preparing at least—a metal substrate;
depositing on said substrate at least a layer of commercially pure zirconium or its alloys in the form of powder;
cutting said layer with at least a laser beam having a ratio between power and translation speed between 0.12-0.20 W·s/mm.

2. Procedure according to claim 1, comprising at least a phase of preparation of at least a support moving vertically for said metal substrate.

3. Procedure according to claim 2, comprising at least a phase of lowering said support by a distance corresponding to the thickness of said layer.

4. Procedure according to claim 1, in which said phase of depositing said layer is implemented by means of a mobile distribution part.

5. Procedure according to claim 1, in which said phase of cutting said layer has power and speed enough to determine the melting of the particles of said powder of commercially pure zirconium or its alloys, so as to make at least a solid laminar portion of said metal article.

6. Procedure according to claim 1, in which said layer has a thickness of 20-1000 microns.

7. Procedure according to claim 1, in which the particles of said powder of commercially pure zirconium have a size between 20 microns and 45 microns.

8. Procedure according to claim 1, in which said substrate is made of one or more metals selected from the group consisting of: commercially pure zirconium, zirconium alloys, titanium, titanium alloy, niobium, niobium alloys.

9. Procedure according to claim 1, in which the phases are implemented in the order indicated.

10. Metal article obtained by means of the procedure according to claim 1.

11. Metal article according to claim 10, comprising at least a surface layer with high surface roughness and high porosity made of commercially pure zirconium or its alloys.

12. Metal article according to claim 11, in which said surface layer has a thickness generally between 100 μm and 2000 μm.

13. Metal article according to claim 11, in which said surface layer has a porosity between 40% and 80%.

14. Metal article according to claim 11, in which said surface layer comprises pores with depth generally between 100 μm and 2000 μm, and more in particular between 500 μm and 1000 μm.
